(19) United States
(12) Patent Application Publication
(10) Pub. No.: US 2022/0057681 A1
(43) Pub. Date: Feb. 24, 2022

(54) DISPLAY PANEL AND DISPLAY DEVICE

(71) Applicant: Innolux Corporation, Miao-Li County (TW)

(72) Inventors: Chia-Hao Tsai, Miao-Li County (TW); Yu-Shih Tsou, Miao-Li County (TW); Yung-Hsun Wu, Miao-Li County (TW); Jian-Min Leu, Miao-Li County (TW); Ming-Jou Tai, Miao-Li County (TW); En Jie Chen, Miao-Li County (TW); Yung-Hsin Lu, Miao-Li County (TW)

(73) Assignee: Innolux Corporation, Miao-Li County (TW)

(21) Appl. No.: 17/381,197

(22) Filed: Jul. 21, 2021

(30) Foreign Application Priority Data
Aug. 21, 2020 (CN) 202010848716.2

(51) Int. Cl. G02F 1/1362

(52) U.S. Cl. CPC G02F 1/136286; G02F 1/136222

(57) ABSTRACT

A display panel and a display device are provided. The display panel has a first region and a second region. A finger structure of a pixel unit located in the first region has one extending direction, and a finger structure of a pixel unit located in the second region has at least one extending direction. In particular, a size of the pixel unit in the first region is larger than a size of the pixel unit in the second region.

### CROSS-REFERENCE TO RELATED APPLICATION

This application claims the priority benefit of China application no. 202010848716.2, filed on Aug. 21, 2020. The entirety of the above-mentioned patent application is hereby incorporated by reference herein and made a part of this specification.

### BACKGROUND OF THE INVENTION

### Field of the Invention

The disclosure relates to a panel and an electronic device, and more particularly to a display panel and a display device.

### Description of Related Art

In order to meet narrow bezel or bezel-less design requirements, some techniques propose to place a camera under the display panel. In this way, not only may narrow bezel or bezel-less design requirements be met, but also pictures may be taken while displaying the screen. However, research has found that in the process of capturing images, if the display panel above the camera is turned on, destructive interference may occur, thus affecting image quality. Therefore, how to reduce the occurrence of destructive interference has become one of the issues that R&D personnel urgently want to solve.

### SUMMARY OF THE INVENTION

The disclosure provides a display panel and a display device that help reduce the occurrence of destructive interference.

According to an embodiment of the disclosure, a display panel has a first region and a second region. A finger structure of a pixel unit located in the first region has one extending direction, and a finger structure of a pixel unit located in the second region has at least one extending direction. In particular, a size of the pixel unit in the first region is larger than a size of the pixel unit in the second region.

According to an embodiment of the disclosure, a display device includes a camera and a display panel. The display panel has a first region and a second region. The first region corresponds to the camera. A finger structure of a pixel unit located in the first region has one extending direction, and a finger structure of a pixel unit located in the second region has at least one extending direction.

In order to make the above features and advantages of the disclosure better understood, embodiments are specifically provided below with reference to figures for detailed description as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a display device according to an embodiment of the disclosure.

FIG. 2 is a partial enlarged schematic diagram of pixel units in the first region in FIG. 1 according to the first embodiment of the disclosure.

FIG. 3A and FIG. 3B are respectively two partial enlarged schematic diagrams of pixel units in the second region in FIG. 1 according to the first embodiment of the disclosure.

FIG. 4 is a partial enlarged schematic diagram of pixel units in the first region in FIG. 1 according to the second embodiment of the disclosure.

FIG. 5A and FIG. 5B are respectively two partial enlarged schematic diagrams of pixel units in the second region in FIG. 1 according to the second embodiment of the disclosure.

FIG. 6 is a partial enlarged schematic diagram of pixel units in the first region in FIG. 1 according to the third embodiment of the disclosure.

FIG. 7 is a partial enlarged schematic diagram of pixel units in the second region in FIG. 1 according to the third embodiment of the disclosure.

FIG. 8 is a partial cross-sectional schematic diagram of pixel units in the first region in FIG. 1 according to the fourth embodiment of the disclosure.

FIG. 9 is a partial cross-sectional schematic diagram of pixel units in the second region in FIG. 1 according to the fourth embodiment of the disclosure.

FIG. 10 is a partial cross-sectional schematic diagram of pixel units in the first region in FIG. 1 according to the fifth embodiment of the disclosure.

FIG. 11 is a partial enlarged schematic diagram of a pixel unit in the first region in FIG. 1 according to the sixth embodiment of the disclosure.

### DESCRIPTION OF THE EMBODIMENTS

The disclosure may be understood by referring to the following detailed description in conjunction with the accompanying figures. It should be noted that, in order to facilitate the reader's understanding and the conciseness of the figures, the multiple figures in the disclosure depict a portion of the electronic device/display device, and specific elements in the figures are not drawn according to actual scale. In addition, the number and size of each element in the figures are for illustration, and are not intended to limit the scope of the disclosure. For example, for clarity, the relative size, thickness, and position of each film, region, or structure may be reduced or enlarged.

Certain terms are used throughout the specification and the appended claims of the disclosure to refer to particular elements. Those skilled in the art should understand that electronic equipment manufacturers may refer to the same elements under different names. This specification is not intended to distinguish between elements having the same function but different names. In the following description and claims, the words “having” and “including” or the like are open words, so they should be interpreted as meaning “including but not limited to . . .”

The terminology mentioned in the specification, such as: “up”, “down”, “front”, “rear”, “left”, “right”, etc., are directions referring to the figures. Therefore, the directional terms used are for illustration, not for limiting the disclosure. It should be understood that when an element or film layer is referred to as disposed “on” or “connected” to another element or film layer, the element or film layer may be directly on the other element or film layer or directly connected to the other element or film layer, or there is an inserted element or film layer between the two (indirect case). Conversely, when an element or film layer is referred to as “directly” on or “directly connected” to another element or film layer, there is no intervening element or film layer between the two.

The term “about”, “equal”, “same”, “equivalent”, “substantially”, or “essentially” mentioned in the specification usually means falling within 10% of a given value or range, or means falling within 5%, 3%, 2%, 1%, or 0.5% of a given value or range. In addition, the phrases “the given range is from a first numerical value to a second numerical value” and “the given range falls within the range of a first numerical value to a second numerical value” mean that the given range contains the first numerical value, the second numerical value, and other values in between.

In some embodiments of the disclosure, terms such as “connection”, “interconnection”, etc. regarding bonding and connection, unless specifically defined, may mean that two structures are in direct contact, or that two structures are not in direct contact and there are other structures located between these two structures. The terms of bonding and connecting may also include the case where both structures are movable or both structures are fixed. In addition, the terms “electrically connected” and “coupled” include any direct and indirect electrical connection means.

In addition, terms such as “first” and “second” mentioned in the specification or claims are used to name different elements or to distinguish different embodiments or ranges, and are not used to limit the upper limit or the lower limit of the number of elements and are also not used to limit the manufacturing order or arrangement order of the elements.

An electronic device of disclosure may include a display device, an antenna device, a sensing device, a light-emitting device, or a tiling device, but the disclosure is not limited thereto. The electronic device may include a bendable or flexible electronic device. The electronic device may, for example, include a liquid-crystal layer or a light-emitting diode. The light-emitting diode may include, for example, an organic light-emitting diode (OLED), a mini LED, a micro LED, or a quantum dot light-emitting diode (may include QLED or QDLED), fluorescence, phosphor, or other suitable materials, or a combination of the above, but the disclosure is not limited thereto. The following uses a display device as an electronic device to explain the content of the disclosure, but the disclosure is not limited thereto.

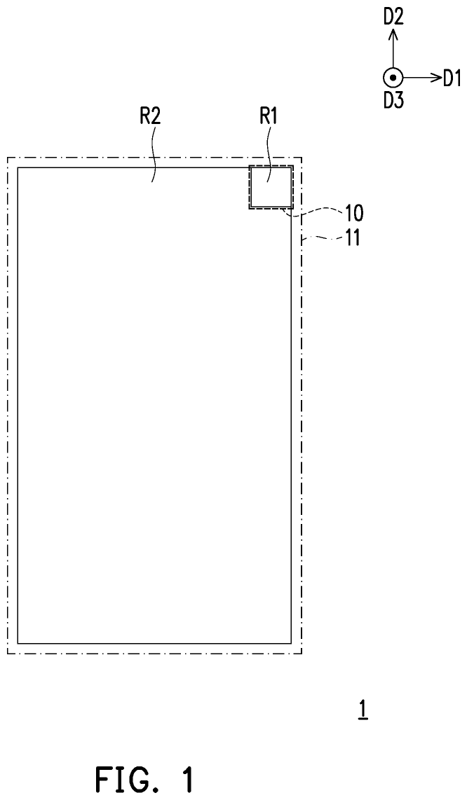

FIG. 1 is a schematic top view of a display device according to an embodiment of the disclosure. Please refer to FIG. 1, a display device 1 of the disclosure may be a non-self-light-emitting display device. The non-self-light-emitting display device may include a liquid-crystal display device, but the disclosure is not limited thereto.

The display device 1 may have a display mode and a photographing mode. In the display mode, the display device 1 provides a display function. In the photographing mode, the display device 1 provides a photographing function.

According to different requirements, the display device 1 may also provide a display function in the photographing mode. For example, the display device 1 may display an acquired image while acquiring an image of a photographed object, but the disclosure is not limited thereto.

In detail, the display device 1 may include a camera 10 and a display panel 11. The camera 10 may provide a photographing function. For example, the camera 10 may include a charge-coupled device (CCD) or a complementary metal-oxide-semiconductor (CMOS) device, but the disclosure is not limited thereto. The display panel 11 may provide a display function. For example, the display panel 11 may include a fringe-field switching (FFS) liquid-crystal display panel or an in-plane switching (IPS) liquid-crystal display panel, but the disclosure is not limited thereto.

The display panel 11 has a first region R1 and a second region R2. The first region R1 corresponds to the camera 10. The region other than the first region R1 is the second region R2. Specifically, the first region R1 of the display panel 11 may be overlapped with the camera 10 in the thickness direction of the display device 1 (such as a third direction D3), and the first region R1 of the display panel 11 is disposed in front of the camera 10, for example. The camera 10 is adapted to receive an image light beam penetrating the first region R1 of the display panel 11, and obtain an image corresponding to the photographed object accordingly. In some embodiments, at least a portion of the first region R1 is overlapped with the camera 10. In some other embodiments, the first region R1 and the camera 10 are substantially completely overlapped.

The second region R2 is adjacent to the first region R1. The second region R2 does not have to be overlapped with the camera 10 in the third direction D3. FIG. 1 schematically shows one square first region R1, and the first region R1 is located at a corner of the second region R2. However, it should be understood that the number, relative arrangement position, top-view shape, or area ratio of the first region R1 and the second region R2 may be changed as needed.

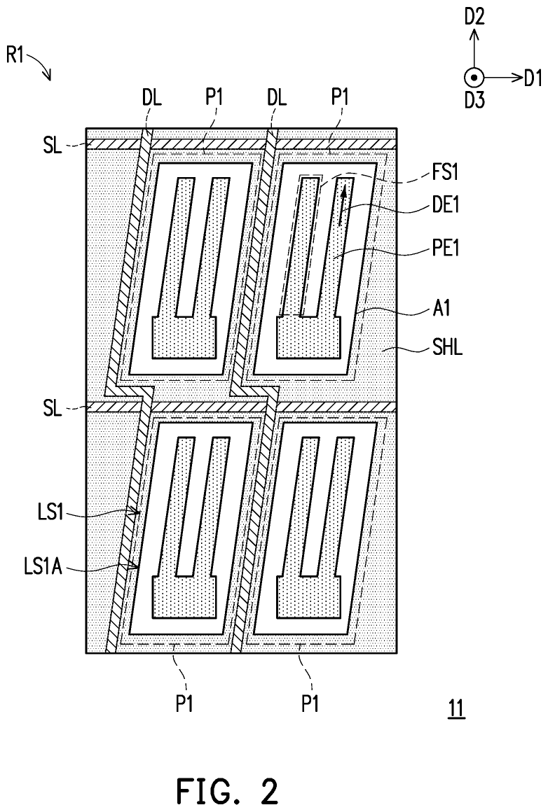

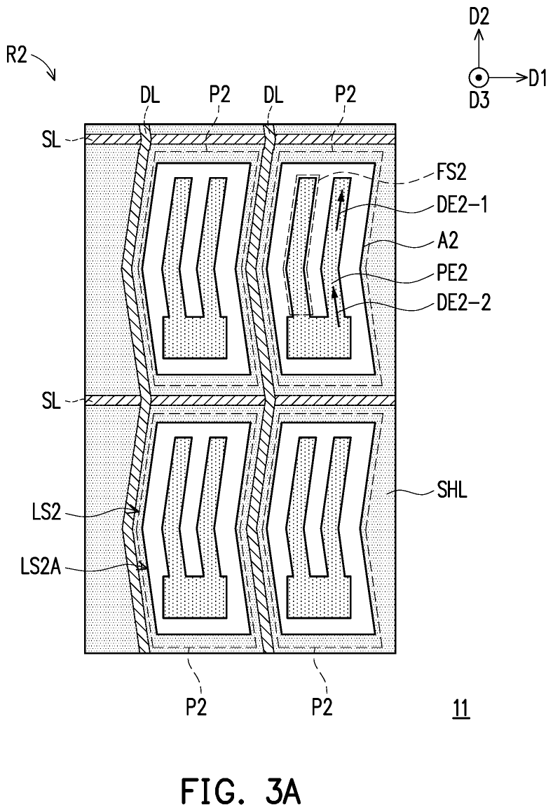

FIG. 2 is a partial enlarged schematic diagram of pixel units in the first region in FIG. 1 according to the first embodiment of the disclosure. FIG. 3A and FIG. 3B are respectively two partial enlarged schematic diagrams of pixel units in the second region in FIG. 1 according to the first embodiment of the disclosure. In other words, in the first embodiment of the disclosure, the pixel units in the first region may adopt the design of FIG. 2, and the pixel units in the second region may adopt any of the designs of FIG. 3A and FIG. 3B.

Referring to FIG. 2 to FIG. 3B, the display panel 11 may include a plurality of pixel units, such as pixel units P1 located in the first region R1 and pixel units P2 located in the second region R2. In some embodiments, the size of the pixel units P1 in the first region R1 may be equal to the size of the pixel units P2 in the second region R2, as shown in FIG. 2 to FIG. 3B. The size of a pixel unit may refer to the width, length, or area of the pixel unit. In some other embodiments, the size of the pixel units P1 in the first region R1 may be larger than the size of the pixel units P2 in the second region R2, that is, the resolution of the first region R1 may be lower than the resolution of the second region R2. The design in which the first region R1 has a lower resolution than the second region R2 helps to increase the pixel pitch or the aperture ratio of the pixel units in the first region R1, thereby helping to reduce the diffraction phenomenon of the first region R1 or improve image quality.

The range of each of the pixel units may be defined by the arrangement of data lines DL and scan lines SL, and each of the pixel units may include an electrode. The electrode may be, for example, a pixel electrode, but the disclosure is not limited thereto. In some embodiments, one pixel unit may include an electrode, and the electrode has one or a plurality of finger structures. For example, the pixel units P1 located in the first region R1 may include an electrode, and the electrode may have one or a plurality of finger structures FS1, and the pixel units P2 located in the second region R2 may include an electrode, and the electrode may have one or a plurality of finger structures F S2.

FIG. 2 schematically shows four pixel units P1 in the first region R1, wherein each of the pixel units P1 includes a pixel electrode PE1, and the pixel electrode PE1 includes two finger structures FS1. FIG. 3A and FIG. 3B schematically show four pixel units P2 in the second region R2, wherein each of the pixel units P2 includes a pixel electrode PE2, and the pixel electrode PE2 also includes two finger structures FS2. In the first region R1 or the second region R2, a plurality of pixel units (such as a plurality of pixel units P1 or a plurality of pixel units P2) are arranged in a first direction D1 and a second direction D2. The second direction D2 is intersected with the first direction D1, and the second direction D2 may be, for example, perpendicular to the first direction D1. The first direction D1 and the second direction D2 may be perpendicular to the thickness direction of the display device 1 (such as the third direction D3). However, it should be understood that the number of pixel units in the first region R1 or the second region R2, the number of finger structures in each of the pixel units, or the arrangement of a plurality of pixel units or the like may be changed as needed. In order to make the subsequent figures easier to understand, the design of the finger structures is shown.

In the disclosure, as shown in FIG. 2, the finger structures FS1 of the pixel units P1 located in the first region R1 have one extending direction DE1 . In other words, all of the finger structures FS1 in the first region R1 are extended in the extending direction DE1. Under this design, the pixel units P1 located in the first region R1 may have a single domain. The design in which the pixel units P1 in the first region R1 have a single domain helps to reduce the probability of destructive interference from the light beam in the first region R1. In this way, in the photographing mode, even if the first region R1 of the display panel 11 is turned on, image quality may still be maintained.

Moreover, the finger structures FS2 of the pixel units P2 located in the second region R2 may have at least one (that is, greater than or equal to 1) extending direction. For example, the finger structures FS2 of the pixel units P2 located in the second region R2 may have one extending direction, or the finger structures FS2 of the pixel units P2 located in the second region R2 may have at least two extending directions (such as an extending direction DE2-1 and an extending direction DE2-2). In some embodiments, as shown in FIG. 3A, the finger structures FS2 of each of the pixel units P2 in the second region R2 may have at least two extending directions (such as the extending direction DE2-1 and the extending direction DE2-2). In some other embodiments, as shown in FIG. 3B, the finger structures FS2 of each of the pixel units P2 in the second region R2 may have a single extending direction (such as the extending direction DE2-1 or the extending direction DE2-2), and two adjacent finger structures FS2 in the second direction D2 in the second region R2 may have different extending directions (such as the extending direction DE2-1 and the extending direction DE2-2). Under this design, the pixel units P2 located in the second region R2 may have at least two domains. The design in which the pixel units P2 in the second region R2 have a plurality of domains helps to improve the viewing angle or achieve a wide viewing angle design. In some other embodiments, all of the finger structures FS2 in the second region R2 may be extended in the same extending direction, that is to say, the pixel units in the second region R2 may have the design of one domain.

In some embodiments, the range of one domain may be substantially the same as one pixel unit. A plurality of pixel units having one domain may be regarded as a plurality of pixel units having the extending direction of one finger structure (as shown in FIG. 2), and a plurality of pixel units having two domains may be regarded as a plurality of pixel units having the extending direction of two finger structures (as shown in FIG. 3A and FIG. 3B), and so on, but the disclosure is not limited thereto.

The display panel 11 may include the scan lines SL and the data lines DL. FIG. 2 to FIG. 3B schematically show two scan lines SL and two data lines DL. The two scan lines SL are alternately arranged with two pixel units (such as two pixel units P1 or two pixel units P2) in the second direction D2 and are extended in the first direction D1. The two data lines DL are alternately arranged with two pixel units (such as two pixel units P1 or two pixel units P2) in the first direction D1. In the present embodiment, a long side LS1 of the pixel units P1 in the first region R1 and a long side LS2 of the pixel units P2 in the second region R2 are substantially parallel to the extending direction of the data lines DL. Moreover, the extending direction of at least a portion of the data lines DL in the first region R1 is parallel to the extending direction DE1 of the finger structures FS1, and the extending direction of at least a portion of the data lines DL in the second region R2 is parallel to the extending direction (such as the extending direction DE2-1 and the extending direction DE2-2) of the finger structures FS2. However, it should be mentioned that, the number, extending direction, or arrangement or the like of the scan lines SL and the data lines DL in the first region R1 or the second region R2 may be changed as needed.

The display panel 11 may further include a shielding layer SHL. The shielding layer SHL has low light transmittance and may be used for shielding light leakage, shielding stray light, shielding elements not intended to be seen by the user, or improving contrast, or the like. For example, the shielding layer SHL may include a black matrix, but the disclosure is not limited thereto. The shielding layer SHL, for example, shields the scan lines SL and the data lines DL, and the shielding layer SHL may have a plurality of openings (such as a plurality of openings A1 and a plurality of openings A2), and the openings respectively expose at least a portion of a region (such as the region where a plurality of pixel electrodes PE1 and a plurality of pixel electrodes PE2 are located) of a plurality of pixel units (such as the plurality of pixel units P1 and the plurality of pixel units P2). In the present embodiment, the extending direction of a long side LS1A of the openings A1 in the first region R1 is also parallel to the extending direction DE1 of the finger structures FS1, and the extending direction of a long side LS2A of the openings A2 in the second region R2 is also parallel to the extending direction of the finger structures FS2 (such as the extending direction DE2-1 and the extending direction DE2-2).

In some other embodiments, the pixel design is different from FIG. 2 to FIG. 3B in that in the display panel, the size of the pixel units P1 in the first region R1 is larger than the size of the pixel units P2 in the second region R2. That is, the resolution of the first region R1 may be lower than the resolution of the second region R2. The design of the first region R1 with a lower resolution than the second region R2 helps to increase the pixel pitch or the aperture ratio of the pixel units in the first region R1, thereby helping to reduce the diffraction phenomenon of the first region R1 or improve image quality. In some embodiments, under the architecture that the resolution of the first region R1 is lower than the resolution of the second region R2, the finger structures FS2 of the pixel units P2 located in the second region R2 may have one extending direction DE2, and the extending direction DE2 may be parallel to the extending direction DE1, but the disclosure is not limited thereto.

According to different requirements, the display panel 11 may also include other elements or film layers. Please refer to existing designs for the design of the remaining elements or film layers in the display panel 11, which is not repeated herein.

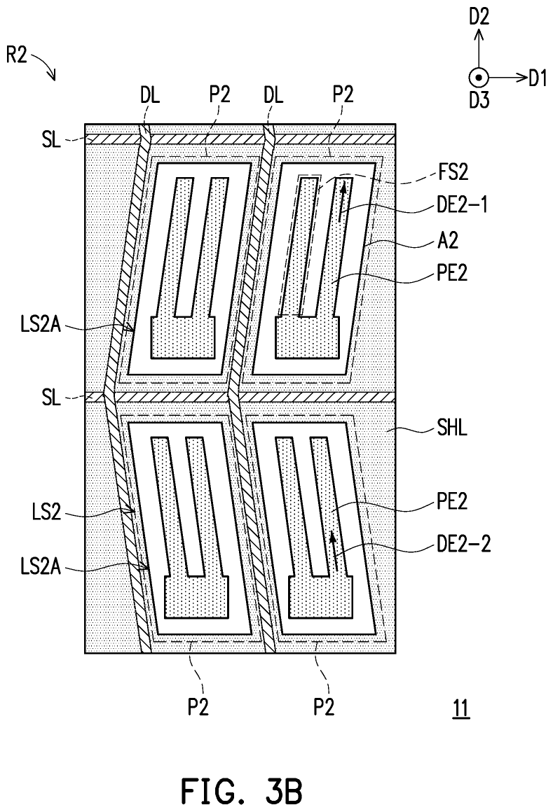

Hereinafter, other embodiments of the display panel are described with reference to FIG. 4 to FIG. 11. In the following embodiments, the same or similar elements adopt the same or similar reference numerals and are not described again. In addition, the features in different embodiments may be mixed and matched arbitrarily as long as they do not violate the spirit of the invention or conflict with each other, and simple equivalent changes and modifications made in accordance with the specification or claims still fall within the scope of the disclosure.

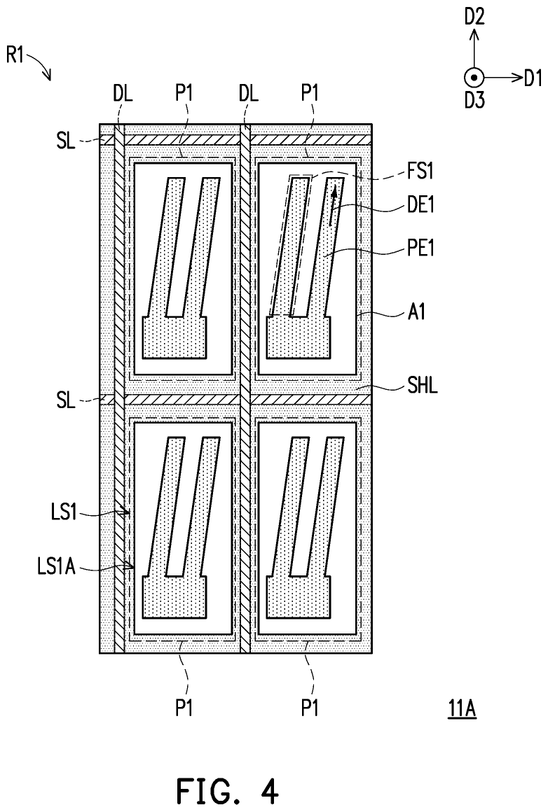

FIG. 4 is a partial enlarged schematic diagram of pixel units in the first region in FIG. 1 according to the second embodiment of the disclosure. FIG. 5A and FIG. 5B are respectively two partial enlarged schematic diagrams of pixel units in the second region in FIG. 1 according to the second embodiment of the disclosure. In other words, in the second embodiment of the disclosure, the pixel units in the first region may adopt the pixel unit design of FIG. 4, and the pixel units in the second region may adopt any of the pixel unit designs of FIG. 5A and FIG. 5B.

Referring to FIG. 4 to FIG. 5B, in a display panel 11A, two scan lines SL and two data lines DL are schematically shown. The two scan lines SL are alternately arranged with two pixel units (such as two pixel units P1 or two pixel units P2) in the second direction D2 and are extended in the first direction D1. The second direction D2 may be intersected with the first direction D1, and the second direction D2 may be, for example, substantially perpendicular to the first direction D1. The extending direction of the data lines DL in the first region R1 is parallel to the second direction D2 and not parallel to the extending direction DE1 of the finger structures FS1, and the extending direction of the data lines DL in the second region R2 is parallel to the second direction D2 and not parallel to the extending direction (such as the extending direction DE2-1 and the extending direction DE2-2) of the finger structures FS2. Moreover, the extending direction of the long side LS1A of the openings A1 of the shielding layer SHL in the first region R1 is also parallel to the second direction D2 and not parallel to the extending direction DE1 of the finger structures FS1, and the extending direction of the long side LS2A of the openings A2 of the shielding layer SHL in the second region R2 is also parallel to the second direction D2 and not parallel to the extending direction (such as the extending direction DE2-1 and the extending direction DE2-2) of the finger structures FS2.

In some other embodiments, the pixel design is different from FIG. 4 to FIG. 5B in that in the display panel, the size of the pixel units P1 in the first region R1 is larger than the size of the pixel units P2 in the second region R2. In some embodiments, under the architecture that the resolution of the first region R1 is lower than the resolution of the second region R2, the finger structures FS2 of the pixel units P2 located in the second region R2 may have one extending direction DE2, and the extending direction DE2 may be parallel to the extending direction DE1, but the disclosure is not limited thereto. In some other embodiments, the extending direction of the data lines DL in the second region R2 and the extending direction of the long side LS2A of the openings A2 of the shielding layer SHL may be different from the extending direction of the data lines DL in the first region R1 and the extending direction of the long side LS1A of the openings A1 of the shielding layer SHL.

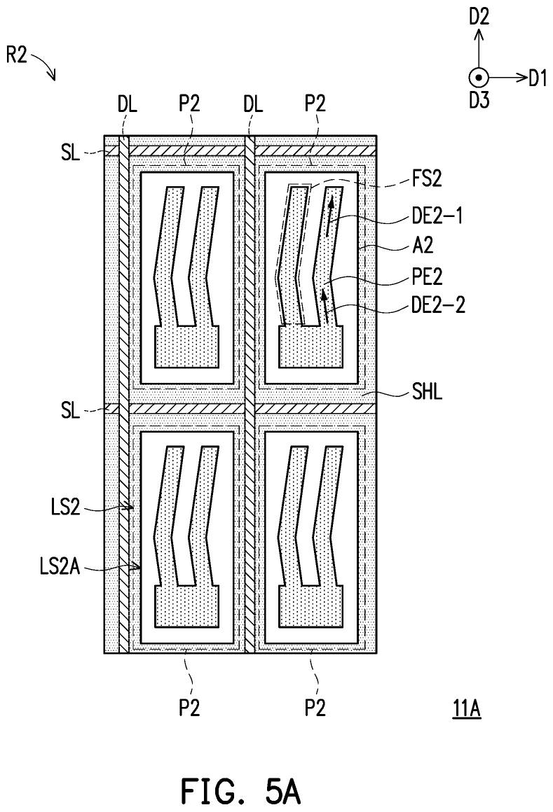

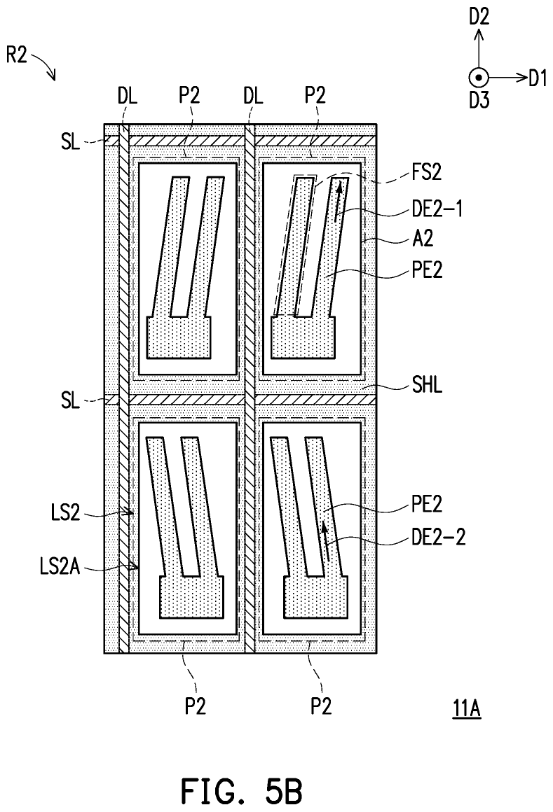

FIG. 6 is a partial enlarged schematic diagram of pixel units in the first region in FIG. 1 according to the third embodiment of the disclosure. FIG. 7 is a partial enlarged schematic diagram of pixel units in the second region in FIG. 1 according to the third embodiment of the disclosure. Referring to FIG. 6 and FIG. 7, in a display panel 11D, the size of the pixel units P1 in the first region R1 is larger than the size of the pixel units P2 in the second region R2. The finger structures FS1 of the pixel units P1 located in the first region R1 may have one extending direction DE1, and the finger structures FS2 of the pixel units P2 located in the second region R2 may have one extending direction DE2. The extending direction DE2 may be parallel to the extending direction DE1, but the disclosure is not limited thereto. In some embodiments, the extending direction DE1 and the extending direction DE2 may be parallel to the first direction D1, but the disclosure is not limited thereto.

In the present embodiment, the long side LS1 of the pixel units P1 in the first region R1 and the long side LS2 of the pixel units P2 in the second region R2 are parallel to the extending direction (such as the first direction D1) of the scan lines SL. The design in which the pixel units P1 and the pixel units P2 are extended in the horizontal direction (such as the first direction D1) helps to reduce the bezel of the display device in the vertical direction (such as the second direction D2). However, in other embodiments, the pixel units P1 in FIG. 6 and the pixel units P2 in FIG. 7 may also be rotated by 90 degrees to form a vertically extending design, so as to reduce the bezel of the display device in the horizontal direction (such as the first direction D1).

In some other embodiments, in a display panel, the size of the pixel units P1 in the first region R1 may be larger than the size of the pixel units P2 in the second region R2. In addition, the pixel units in FIG. 4 to FIG. 5B may be rotated by 90 degrees, and other detailed descriptions are as provided in the descriptions of FIG. 4 to FIG. 5B, which are not repeated herein.

In some other embodiments, in a display panel, the size of the pixel units P1 in the first region R1 may be larger than the size of the pixel units P2 in the second region R2. In addition, the pixel units in FIG. 2 to FIG. 3B may be rotated by 90 degrees, and other detailed descriptions are as provided in the descriptions of FIG. 2 to FIG. 3B, which are not repeated herein.

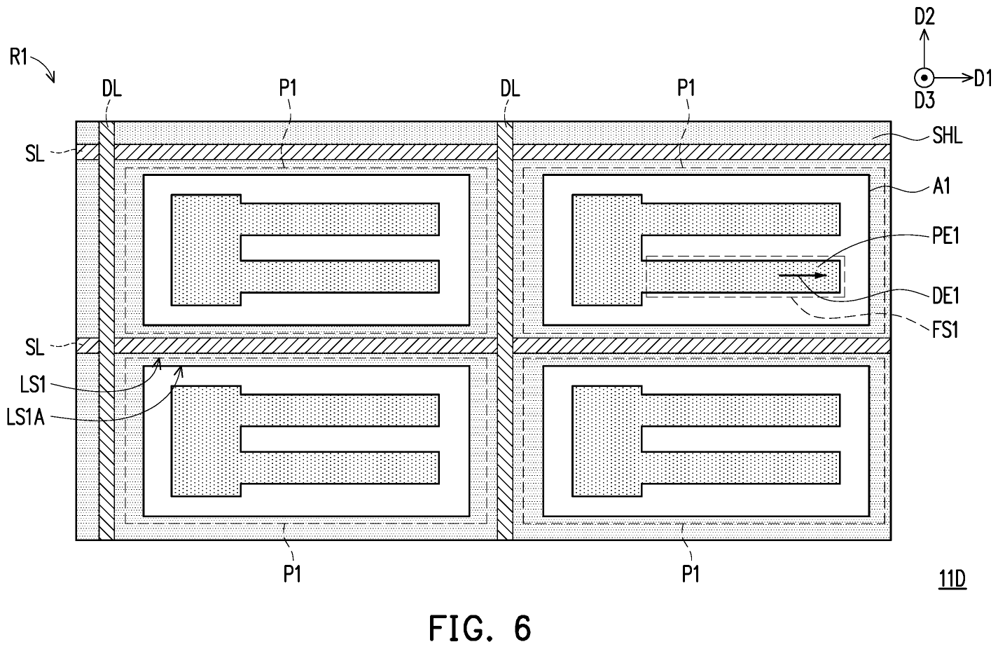

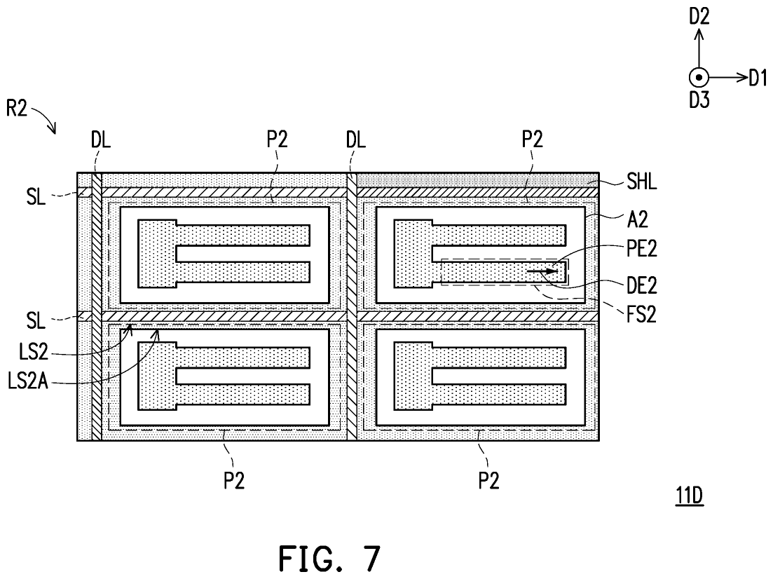

FIG. 8 is a partial cross-sectional schematic diagram of pixel units in the first region in FIG. 1 according to the fourth embodiment of the disclosure. FIG. 9 is a partial cross-sectional schematic diagram of pixel units in the second region in FIG. 1 according to the fourth embodiment of the disclosure. Referring to FIG. 8 and FIG. 9, in a display panel 11G, the size of the pixel units P1 in the first region R1 is larger than the size of the pixel units P2 in the second region R2.

As shown in FIG. 8 and FIG. 9, in addition to the finger structures FS1 of the pixel electrodes PE1, the finger structures FS2 of the pixel electrodes PE2, the scan lines (not shown in FIG. 8 and FIG. 9), the data lines DL, and the shielding layer SHL, the display panel 11G may further include a substrate SUB1, a buffer layer BL, a gate insulating layer GI, an insulating layer IN1, an insulating layer IN2, a common electrode layer COM, an insulating layer IN3, a display medium layer DML, a protective layer PT, a transparent photoresist layer PR, a plurality of color filter patterns (such as a plurality of green filter patterns CF1, a plurality of blue filter patterns CF2, and a plurality of red filter patterns CF3), and a substrate SUB2.

The substrate SUB1 and the substrate SUB2 may be used to carry elements. The substrate SUB1 and the substrate SUB2 may be bendable, flexible, or rigid. The substrate SUB1 and the substrate SUB2 may be curved, flat, or a combination of the above. For example, any of the substrate SUB1 and the substrate SUB2 may include a glass substrate, a plastic substrate, a resin substrate, or a combination of at least two of the above, but the disclosure is not limited thereto.

The buffer layer BL is disposed on the substrate SUB1. The buffer layer BL may be used to reduce contamination of the semiconductor layer (not shown) from impurities in the substrate SUB1. For example, the material of the buffer layer BL may include silicon dioxide, silicon nitride, photoresist material, or a combination of at least two of the above, but the disclosure is not limited thereto.

The gate insulating layer GI is disposed on the buffer layer BL. For example, the material of the gate insulating layer GI may include silicon dioxide, silicon nitride, or a combination of two of the above, but the disclosure is not limited thereto.

The data lines DL are disposed on the gate insulating layer GI, and the insulating layer IN1 is disposed on the data lines DL and the gate insulating layer GI. Based on the consideration of signal transmission, the material of the data lines DL may be a material with low impedance or high conductivity, such as metal, alloy, or a combination of two of the above, but the disclosure is not limited thereto. The material of the insulating layer IN1 may include silicon dioxide, silicon nitride, or a combination of two of the above, but the disclosure is not limited thereto.

The insulating layer IN2 is disposed on the insulating layer IN1. For example, the material of the insulating layer IN2 may include an organic material, but the disclosure is not limited thereto.

The common electrode layer COM is disposed on the insulating layer IN2.

Based on the consideration of aperture ratio, the material of the common electrode layer COM may be a material with high light transmittance, such as metal oxide, metal mesh, or a combination of the two, but the disclosure is not limited thereto.

The insulating layer IN3 is disposed on the common electrode layer COM. For example, the material of the insulating layer IN3 may include silicon dioxide, silicon nitride, or a combination of two of the above, but the disclosure is not limited thereto.

The pixel electrodes (such as the pixel electrodes PE1 or the pixel electrodes PE2) are disposed on the insulating layer IN3. More specifically, the finger structures of the pixel electrodes (such as the finger structures FS1 or the finger structures FS2) are disposed on the insulating layer IN3. Based on the consideration of aperture ratio, the material of the pixel electrodes may be a material with high light transmittance, such as metal oxide, metal mesh, or a combination of the two, but the disclosure is not limited thereto.

The shielding layer SHL is disposed on the substrate SUB2 and faces the substrate SUB1, wherein the shielding layer SHL is overlapped with the data lines DL in the third direction D3, and the openings (such as the openings A1 or the openings A2) of the shielding layer SHL expose at least a portion of the pixel electrodes (such as the finger structures FS1 or the finger structures FS2 of the pixel electrodes) in the third direction D3.

In the first region R1, the transparent photoresist layer PR is disposed on the shielding layer SHL and the substrate SUB2 and faces the substrate SUB1. Moreover, in the second region R2, a plurality of color filter patterns (such as the plurality of green filter patterns CF1, the plurality of blue filter patterns CF2, and the plurality of red filter patterns CF3) are disposed on the shielding layer SHL and the substrate SUB2 and face the substrate SUB1. In other words, the pixel units P1 in the first region R1 do not include a color filter pattern, and the pixel units P2 in the second region R2 include a color filter pattern. Under this design architecture, the first region R1 may be used for black and white display, that is, the pixel units P1 in the first region R1 switch between a black screen and a white screen without providing a color display function. Via the design in which the pixel units P1 in the first region R1 do not include a color filter pattern, the light transmittance of the pixel units P1 in the first region R1 may be improved or the diffraction phenomenon of the first region R1 may be reduced. Under the architecture of FIG. 8, the pixel units P1 in the first region R1 may also be matched with a color sequential back light to provide a color display function.

The protective layer PT is disposed on the transparent photoresist layer PR and the plurality of color filter patterns (such as the plurality of green filter patterns CF1, the plurality of blue filter patterns CF2, and the plurality of red filter patterns CF3) and faces the substrate SUB1. The material of the protective layer PT may be any of the above insulating layer materials, which is not repeated herein.

The display medium layer DML is located between the protective layer PT and at least a portion of the pixel electrodes (such as the finger structures FS1 or the finger structures FS2 of the pixel electrodes). The display medium layer DML is, for example, a liquid-crystal layer, but the disclosure is not limited thereto.

It should be understood that the number of elements or film layers in the display panel 11G may be increased or decreased as needed, and is not limited to those shown in FIG. 8 and FIG. 9.

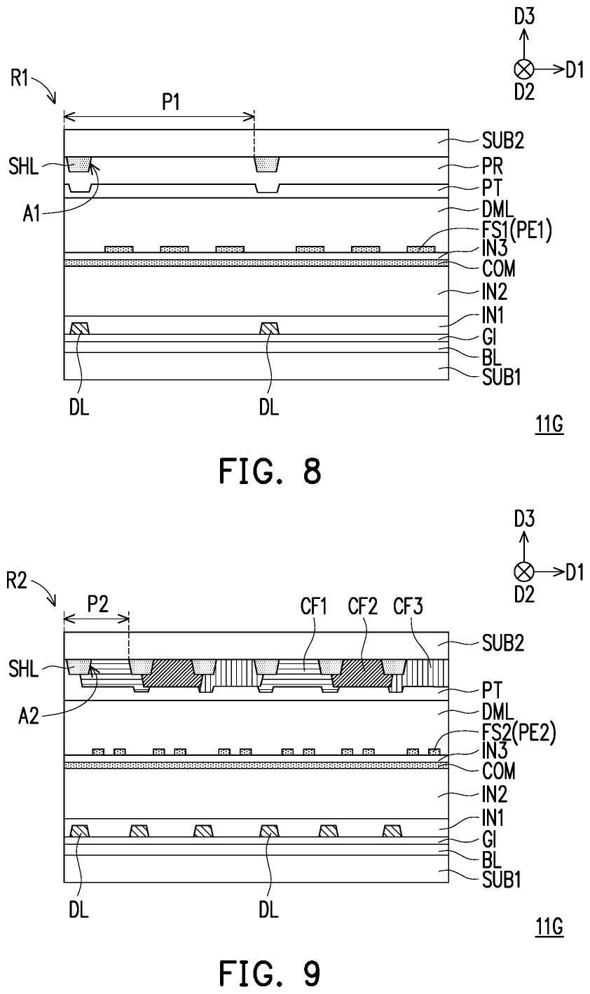

FIG. 10 is a partial cross-sectional schematic diagram of pixel units in the first region in FIG. 1 according to the fifth embodiment of the disclosure. Referring to FIG. 10, in a display panel 11H, a first portion P11 of the pixel units P1 in the first region R1 includes a color filter pattern (such as any of the green filter patterns CF1, the blue filter patterns CF2, and the red filter patterns CF3), and a second portion P12 of the pixel units P1 in the first region R1 does not include a color filter pattern. Under this design architecture, the first portion P11 of the pixel units P1 may provide a color display function, and the second portion P12 of the pixel units P1 may provide a black and white display function. In some other embodiments, the first portion P11 of the pixel units P1 in the first region R1 may include a plurality of color filter patterns. For example, the first portion may include the green filter patterns CF1, the blue filter patterns CF2, and the red filter patterns CF3. It should be understood that the width ratio or the area ratio of the first portion P11 to the second portion P12 may be based on actual need, and is not limited to that shown in FIG. 10.

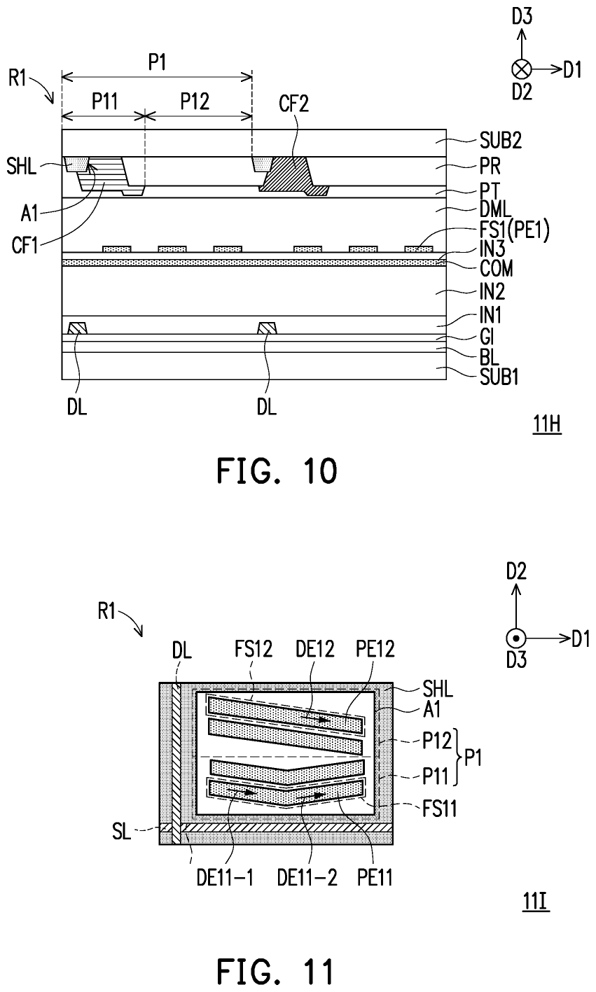

FIG. 11 is a partial enlarged schematic diagram of a pixel unit in the first region in FIG. 1 according to the sixth embodiment of the disclosure. Referring to FIG. 11, in a display panel 11I, finger structures FS11 of pixel electrodes PE11 in the first portion P11 of the pixel unit P1 in the first region R1 (that is, the portion where the pixel unit P1 includes a color filter pattern) may have at least two (that is, greater than or equal to 2) extending directions (such as an extending direction DE11-1 and an extending direction DE11-2), and finger structures FS12 of pixel electrodes PE12 in the second portion P12 of the pixel unit P1 in the first region R1 (that is, the portion where the pixel unit P1 does not include a color filter pattern) may have one extending direction DE12. Under this design, the first portion P11 of the pixel unit P1 may have at least two domains, thus helping to improve the viewing angle or achieve a wide viewing angle design. Moreover, the second portion P12 of the pixel unit P1 may have a single domain, thus helping to reduce the probability of destructive interference of the light beam in the second portion P12, thereby maintaining image quality. It should be understood that, the pixel electrodes (such as the pixel electrodes PE11 a the pixel electrodes PE12) in FIG. 11 schematically show the portion where the finger structures (such as the finger structures FS11 and the finger structures FS12) are located. However, the pixel electrodes may optionally include other portions as needed (such as the rectangular portions connected to one end of the plurality of finger structures in FIG. 2, but the disclosure is not limited thereto).

Based on the above, in an embodiment of the disclosure, the first region may be designed with a lower resolution than the second region to reduce the diffraction phenomenon in the first region or improve image quality. In some embodiments, the design in which the finger structures of the pixel units in the first region have one extending direction (that is, having a single domain) helps to reduce the probability of destructive interference of the light beam in the first region. In this way, in the photographing mode, even if the first region of the display panel is turned on, image quality may still be maintained. In addition, the design in which the finger structures of the pixel units in the second region have at least two extending directions (that is, having a plurality of domains) helps to improve the viewing angle or achieve a wide viewing angle design. In some embodiments, the horizontal extension design of the pixel units may be used to reduce the vertical bezel of the display device. In some embodiments, the vertical extension design of the pixel units may be used to reduce the horizontal bezel of the display device. In some embodiments, the pixel units in the first region do not need to include a color filter pattern, so as to improve the light transmittance of the pixel units in the first region or reduce the diffraction phenomenon of the first region. In some embodiments, the first portion of the pixel units in the first region may include a color filter pattern, and the second portion of the pixel units in the first region do not need to include a color filter pattern, so as to take into account the display and photographing effects of the first region.

The above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

Although the embodiments of the disclosure and their advantages are disclosed as above, it should be understood that any person skilled in the art, without departing from the spirit and scope of the disclosure, may make changes, substitutions, and modifications, and features between the embodiments may be mixed and replaced at will to form other new embodiments. In addition, the scope of the disclosure is not limited to the manufacturing processes, machines, manufactures, material compositions, devices, methods, and steps in the specific embodiments described in the specification. Any person skilled in the art may understand the current or future development processes, machines, manufactures, material compositions, devices, methods, and steps from the content of the disclosure, which may all be adopted according to the disclosure as long as they may implement substantially the same function or obtain substantially the same result in an embodiment described here. Therefore, the scope of the disclosure includes the above manufacturing processes, machines, manufactures, material compositions, devices, methods, and steps. In addition, each claim constitutes an individual embodiment, and the scope of the disclosure also includes the

File: 101636usf combination of each claim and embodiment. The scope of the disclosure shall be subject to the scope defined by the following claims.

What is claimed is:

1. A display panel, wherein the display panel has a first region and a second region, wherein a finger structure of a pixel unit located in the first region has one extending direction, and a finger structure of a pixel unit located in the second region has at least one extending direction,
wherein a size of the pixel unit in the first region is larger than a size of the pixel unit in the second region.

2. The display panel of claim 1, wherein the pixel unit in the first region does not comprise a color filter pattern, and the pixel unit in the second region comprises a color filter pattern.

3. The display panel of claim 1, wherein a first portion of the pixel unit in the first region comprises a color filter pattern, and a second portion of the pixel unit in the first region does not comprise a color filter pattern.

4. The display panel of claim 3, wherein a finger structure of the first portion has at least two extending directions, and a finger structure of the second portion has one extending direction.

5. The display panel of claim 1, further comprising a data line, and a long side of the pixel unit in the first region and a long side of the pixel unit in the second region are parallel to an extending direction of the data line.

6. The display panel of claim 1, further comprising a scan line, and a long side of the pixel unit in the first region and a long side of the pixel unit in the second region are parallel to an extending direction of the scan line.

7. The display panel of claim 1, further comprising a color sequential back light correspondingly disposed at the first region.

8. The display panel of claim 1, wherein the extending direction of the finger structure of the pixel unit in the first region is parallel to a long side of the pixel unit in the first region.

9. The display panel of claim 1, wherein the extending direction of the finger structure of the pixel unit in the first region is not parallel to a long side of the pixel unit in the first region.

10. The display panel of claim 1, wherein the at least one extending direction of the finger structure of the pixel unit in the second region is parallel to a long side of the pixel unit in the second region.

11. The display panel of claim 1, wherein the at least one extending direction of the finger structure of the pixel unit in the second region is not parallel to a long side of the pixel unit in the second region.

12. A display device, comprising a camera and a display panel, wherein the display panel has a first region and a second region, and the first region corresponds to the camera, wherein a finger structure of a pixel unit located in the first region has one extending direction, and a finger structure of a pixel unit located in the second region has at least one extending direction.

13. The display device of claim 12, wherein a size of the pixel unit in the first region is larger than a size of the pixel unit in the second region.

14. The display device of claim 12, wherein the pixel unit in the first region does not comprise a color filter pattern, and the pixel unit in the second region comprises a color filter pattern.

15. The display device of claim 12, wherein a first portion of the pixel unit in the first region comprises a color filter pattern, and a second portion of the pixel unit in the first region does not comprise a color filter pattern.

16. The display device of claim 15, wherein a finger structure of the first portion has at least two extending directions, and a finger structure of the second portion has one extending direction.

17. The display device of claim 12, wherein the display panel further comprises a data line, and a long side of the pixel unit in the first region and a long side of the pixel unit in the second region are parallel to an extending direction of the data line.

18. The display device of claim 12, wherein the display panel further comprises a scan line, and a long side of the pixel unit in the first region and a long side of the pixel unit in the second region are parallel to an extending direction of the scan line.

19. The display device of claim 12, wherein the display panel further comprises a color sequential back light correspondingly disposed at the first region.

20. The display device of claim 12, wherein the extending direction of the finger structure of the pixel unit in the first region is not parallel to a long side of the pixel unit in the first region, and the at least one extending direction of the finger structure of the pixel unit in the second region is not parallel to a long side of the pixel unit in the second region.
